(19) United States
(12) Patent Application Publication
(10) Pub. No.: US 2009/0262938 A1
(43) Pub. Date: Oct. 22, 2009

(54) METHOD FOR ENCRYPTING AND DECRYPTING WIRELESS SIGNALS AND APPARATUS THEREOF

(75) Inventor: CHIH KUN CHANG, HSINCHU HSIEN (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/395,431

(22) Filed: Feb. 27, 2009

(30) Foreign Application Priority Data
Apr. 21, 2008 (TW) 097114453

(51) Int. Cl. H04L 9/00

(52) U.S. Cl. 380/270

(57) ABSTRACT

An apparatus for encrypting wireless signals comprises an encryption engine, a transmit packet buffer and a transmit control logic. The encryption engine encrypts the wireless signals. The transmit packet buffer stores the encrypted wireless signals. The transmit control logic forwards the encrypted wireless signal from the transmit packet buffer to a wireless channel.

### BACKGROUND OF THE INVENTION

1. Field of the Invention

The present invention relates to encryption/decryption methods and apparatus applied to a wireless signal transmission, and more particularly, to encryption/decryption methods and apparatus executing a high-speed signal transmission.

2. Description of the Related Art

With the dramatic development of wireless communication devices in recent years, increasing utilization of wireless signal transmission initiates an important issue of signal transmission security. If the security cannot be guaranteed, the widespread utilization of wireless communications will be impeded. Of particular importance to businesses, prevention of hacking and online theft of information is the utmost priority when building secure networks.

FIG. 1 shows a diagram of a conventional encryption/decryption apparatus applied in a wireless communication system. The encryption/decryption apparatus 101 includes a packet-transmitting buffer 102, an encryption engine 103, a transmit control logic 104, a packet-receiving buffer 105, a decryption engine 106 and a receive control logic 107. In a transmission stage, the encryption/decryption apparatus 101 receives signals intended for transmission from a host 108, and stores these signals in the packet-transmitting buffer 102. Next, when the transmit control logic 104 is available to transmit, it reads the signals intended for transmission from the packet-transmitting buffer 102 through the encryption of the encryption engine 103, and transmits them to a wireless communication channel 109. However, when operating in a high-speed transmission, the read action of the transmit control logic 104 is faster than the encryption action of the encryption engine 103, and thus signal loss occurs and transmission efficiency is lowered. Also, when operating in a receiving stage, a similar loss of signal and efficiency occurs.

FIG. 2 shows another conventional encryption/decryption apparatus applied in a wireless communication system. The encryption/decryption apparatus 201 includes a packet-transmitting buffer 202, an encryption engine 203, a transmit control logic 204, a packet-receiving buffer 205, a decryption engine 206 and a receive control logic 207. In the transmission stage, the encryption/decryption apparatus 201 receives signals intended for transmission from a host 208, and stores these signals in the packet-transmitting buffer 202. The encryption engine 203 reads the signals intended for transmission from the packet-transmitting buffer 202, and restores the signals back to the packet-transmitting buffer 202 after executing an encryption action. Next, when the transmit control logic 204 is available to transmit, it reads the signals intended for transmission from the packet-transmitting buffer 202 and transmits them to a wireless communication channel 209. However, when operating a high-speed transmission, because the packet-transmitting buffer 202 must deal with the encryption engine 203 and the access of the transmit control logic 204, a high-bandwidth buffer has to be used. This increases the cost of the encryption/decryption apparatus 201. Similar limitations apply to the receiving stage.

### SUMMARY OF THE INVENTION

The encryption apparatus applied to wireless transmission in accordance with one embodiment of the present invention comprises an encryption engine, a packet-transmitting buffer and a transmit control logic. The encryption engine is configured to perform an encryption upon signals in a host. The packet-transmitting buffer is configured to store the encrypted signals. The transmit control logic is configured to transmit the encrypted signals stored in the packet-transmitting buffer to a wireless network channel.

The decryption apparatus applied to wireless transmission in accordance with one embodiment of the present invention comprises a receive control logic, a packet-receiving buffer and a decryption engine. The receive control logic is configured to receive signals intended for decryption from a wireless network channel. The packet-receiving buffer is configured to store the signals intended for decryption. The decryption engine is configured to perform a decryption upon signals stored in the packet-receiving buffer and then to transmit the decrypted signals to a host.

The wireless transceiver in accordance with one embodiment of the present invention comprises a transmitter and a receiver. The transmitter comprises an encryption engine, a packet-transmitting buffer and a transmit control logic. The encryption engine is configured to perform an encryption upon signals in a host. The packet-transmitting buffer is configured to store the encrypted signals. The transmit control logic is configured to transmit the encrypted signals stored in the packet-transmitting buffer. The receiver comprises a receive control logic, a packet-receiving buffer and a decryption engine. The receive control logic is configured to receive signals intended for decryption. The packet-receiving buffer is configured to store the signals intended for decryption. The decryption engine is configured to perform a decryption upon signals stored in the packet-receiving buffer and then to transmit the decrypted signals to another host.

The encryption method applied to wireless transmission in accordance with one embodiment of the present invention comprises the steps of: performing an encryption procedure upon signals intended for encryption in a host; storing the encrypted signals to a buffer; and transmitting the encrypted signals stored in the buffer to a wireless network channel.

The decryption method applied to wireless transmission in accordance with one embodiment of the present invention comprises the steps of: storing signals intended for decryption from a wireless network channel to a buffer; performing a decryption procedure upon signals intended for decryption from the buffer; and transmitting the decrypted signals to a host.

### BRIEF DESCRIPTION OF THE DRAWINGS

The invention will be described according to the appended drawings in which:

FIG. 1 shows a diagram of a conventional encryption/decryption apparatus applied in a wireless communication system;

FIG. 2 shows another conventional encryption/decryption apparatus applied in a wireless communication system;

FIG. 3(a) shows an encryption apparatus applied in a wireless signal transmission in accordance with one embodiment of the present invention;

FIG. 3(b) shows an embodiment of the encryption engine in FIG. 3(a);

FIG. 4(a) shows a decryption apparatus applied in a wireless signal transmission in accordance with one embodiment of the present invention;

FIG. 4(b) shows an embodiment of the decryption engine in FIG. 4(a); and

FIG. 5 shows an encryption/decryption apparatus applied in a wireless signal transmission in accordance with one embodiment of the present invention;

FIG. 6 shows an encryption flow in accordance with one embodiment of the present invention; and

FIG. 7 shows a decryption flow in accordance with one embodiment of the present invention.

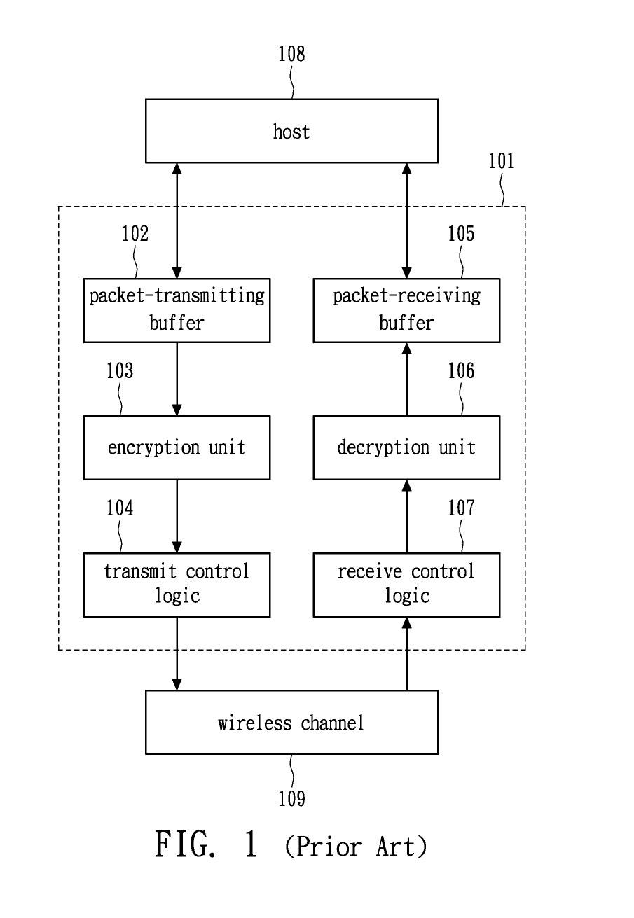

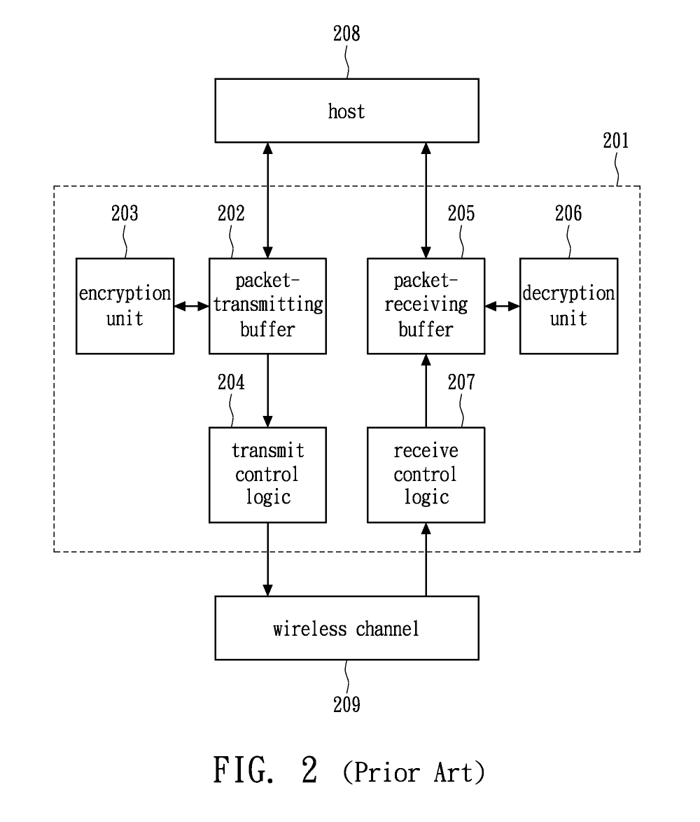

### PREFERRED EMBODIMENT OF THE PRESENT INVENTION

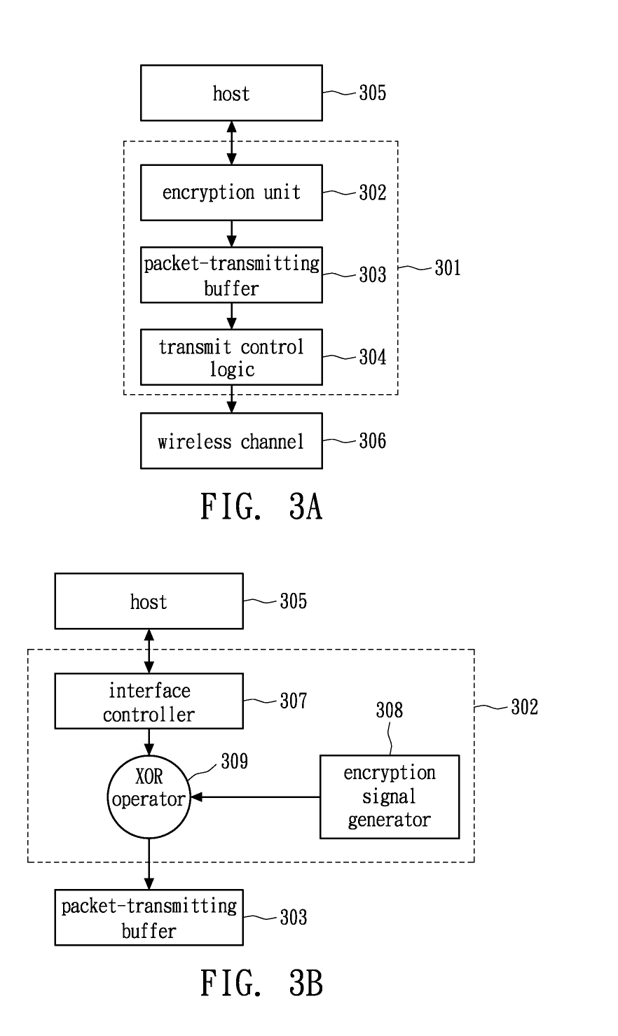

FIG. 3(a) shows an encryption apparatus applied in a wireless signal transmission in accordance with one embodiment of the present invention. The encryption apparatus 301 includes an encryption engine 302, a packet-transmitting buffer 303 and a transmit control logic 304. The encryption engine 302 performs an encryption action upon signals intended for transmission and then stores them in the packet-transmitting buffer 303. When the transmit control logic 304 is in a state that is capable of transmitting signals, it reads the encrypted signals from the packet-transmitting buffer 303 and transmits them to a wireless communication channel 306.

FIG. 3(b) shows an embodiment of the encryption engine 302 in FIG. 3(a). The encryption engine 302 includes an interface controller 307, an encryption signal generator 308 and an exclusive-or (XOR) operator 309. The interface controller 307 receives signals intended for encryption from the host 305. The encryption signal generator 308 is used to generate an encryption code. The XOR operator 309 performs an XOR operation upon signals received from the interface controller 307 and code generated by the encryption signal generator 308 so as to generate encrypted signals and store them in the packet-transmitting buffer 303. Because the step in which the interface controller 307 receives the encrypted signals is synchronous to the step in which the encryption signal generator 308 generates the encryption code, compared to the apparatus without an encryption mechanism, the extra transmission delay caused by the encryption engine 302 approximates to the operation speed of the XOR operator 309.

Referring to FIG. 3(a), the transmit control logic 304 receives signals from the packet-transmitting buffer 303 and transmits them only in the condition that is available to transmit, while the encryption engine 302 directly performs an encryption action upon the signals intended for transmission and then stores them in the packet-transmitting buffer 303; these two actions are not synchronous. Therefore, even though the encryption engine 302 causes some transmission delays, the time difference between these two actions compensates for these delays. Consequently, the transmission speed of the encryption apparatus 301 is equal to or close to that of the wireless signal transmission apparatus without an encryption mechanism.

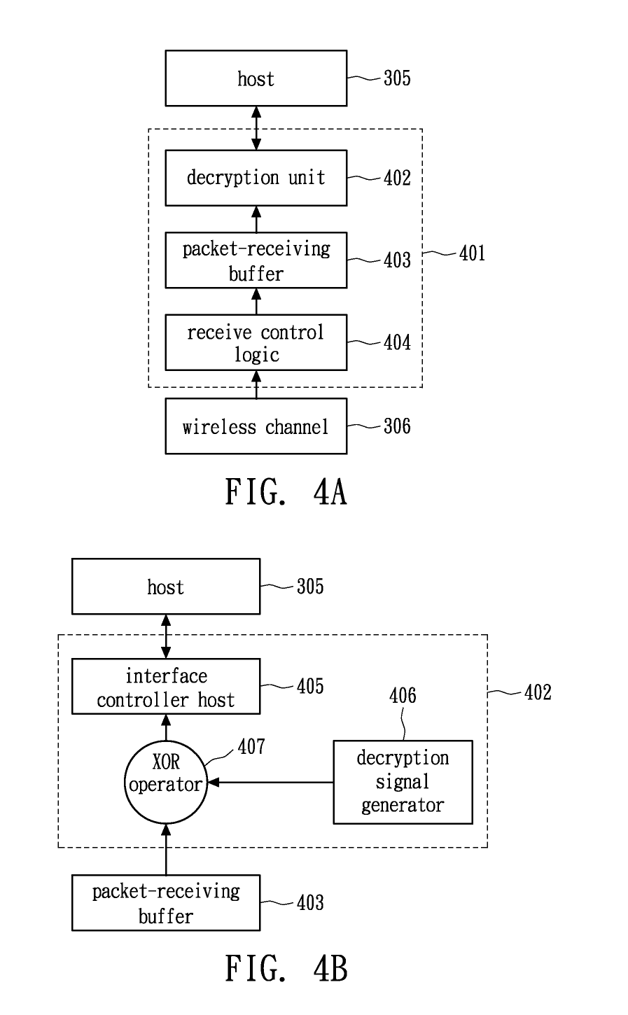

FIG. 4(a) shows a decryption apparatus applied in a wireless signal transmission in accordance with one embodiment of the present invention. The decryption apparatus 401 includes a decryption engine 402, a packet-receiving buffer 403 and a receive control logic 404. The receive control logic 404 receives signals intended for decryption from the wireless communication channel 306 and stores them to the packet-receiving buffer 403. The decryption engine 402 reads the signal intended for decryption from the packet-receiving buffer 403, performs a decryption action, and transmits them to the host 305.

FIG. 4(b) shows an embodiment of the decryption engine 402 in FIG. 4(a). The decryption engine 402 includes an interface controller 405, a decryption signal generator 406 and an exclusive-or (XOR) operator 407. The decryption signal generator 402 is used to read signals intended for decryption from the packet-receiving buffer 403. The decryption signal generator 406 generates a decryption code. These two signals generate decrypted signals based on an XOR operation by the XOR operator 407. The decrypted signals are transmitted to the host 305 through the interface controller 405. Based on the same theorem of the encryption engine 302 in FIG. 3(b), reading the signals intended for decryption from the packet-receiving buffer 403 is synchronous to generating the decryption code by the decryption signal generator 406. Compared to the apparatus without a decryption mechanism, the extra transmission delay caused by the decryption engine 402 approximates to the operation speed of the XOR operator 407.

Referring to FIG. 4(a), with the same theorem of encryption apparatus 301, the receive control logic 404 receives signals intended for decryption and stores them in the packet-receiving buffer 403 only in the condition that is available to receive, while the decryption engine 402 directly performs a decryption action upon the signals from the packet-receiving buffer 403; these two actions are not synchronous. Therefore, even though the decryption engine 402 causes some transmission delays, the time difference between these two actions compensates for these delays. Consequently, the transmission speed of the decryption apparatus 401 is equal to or close to that of the wireless signal transmission apparatus without a decryption mechanism.

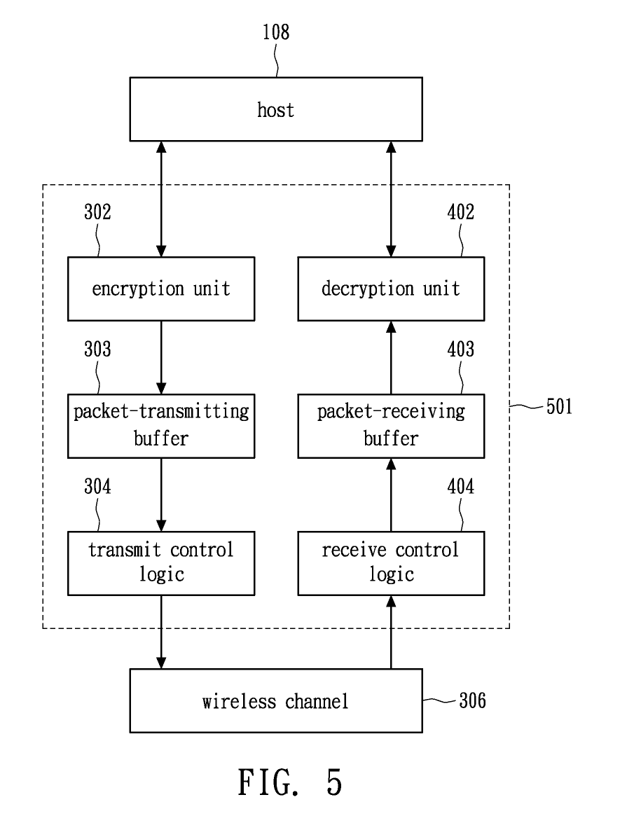

FIG. 5 shows an encryption/decryption apparatus applied in a wireless signal transmission in accordance with one embodiment of the present invention. The encryption/decryption apparatus 501 integrates the encryption apparatus 301 and decryption apparatus 401 of the previous embodiments, which includes an encryption engine 302, a packet-transmitting buffer 303, a transmit control logic 304, a decryption engine 402, a packet-receiving buffer 403 and a receive control logic 404. The encryption/decryption apparatus 501 receives signals intended for transmission from the host 305. The encryption engine 302 performs an encryption action upon signals intended for transmission and then stores them in the packet-transmitting buffer 303. When the transmit control logic 304 is in a state that is capable to transmit signals, it reads the encrypted signals from the packet-transmitting buffer 303 and transmits them to a wireless communication channel 306. The receive control logic 404 receives signals intended for decryption from the wireless communication channel 306 and stores them to the packet-receiving buffer 403. The decryption engine 402 reads the signal intended for decryption from the packet-receiving buffer 403, performs a decryption action, and transmits them to the host 305. The encryption/decryption apparatus 501 integrates the advantages of the encryption apparatus 301 and decryption apparatus 401; thus its transmission speed is equal to or close to that of the wireless signal transmission apparatus without an encryption/decryption mechanism.

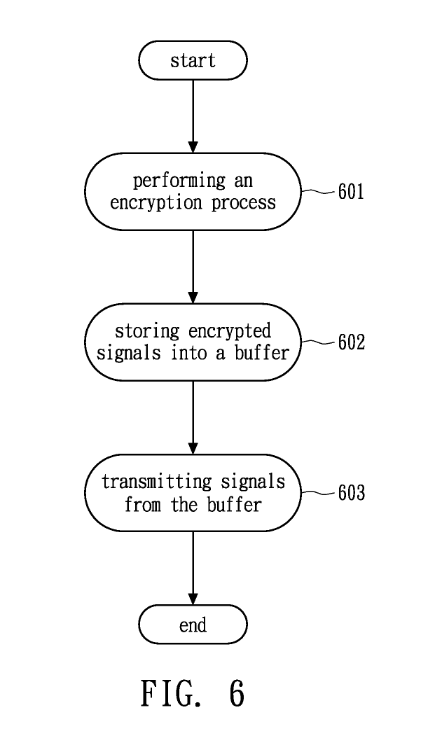

FIG. 6 shows an encryption flow in accordance with one embodiment of the present invention. In Step 601, the signals intended for encryption go through an encryption process. In Step 602, the encrypted signals are stored in a buffer. In Step 603, the transmitted signals are retrieved from the buffer. The encryption process in Step 601 generates signals intended for transmission by performing an XOR operation upon the encryption code and signals intended for encryption.

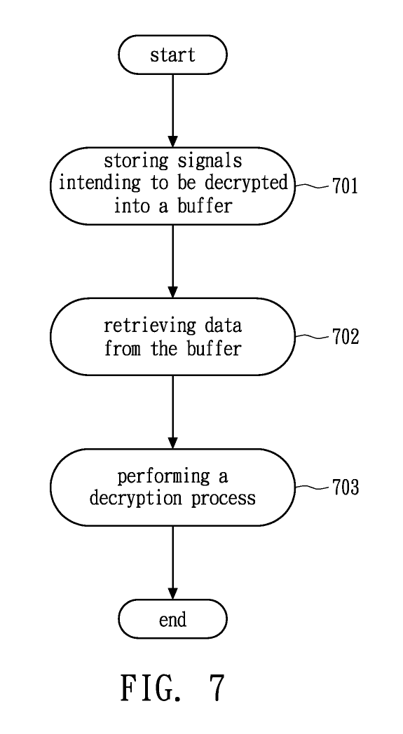

FIG. 7 shows a decryption flow in accordance with one embodiment of the present invention. In Step 701, the signals intended for decryption are stored in a buffer. In Step 702, the signals intended for decryption are retrieved from the buffer. In Step 703, a decryption operation is performed upon signals intended for decryption. The decryption process in Step 701 generates signals intended for decryption by performing an XOR operation upon the decryption code and signals intended for decryption.

The encryption/decryption apparatus applied in a wireless signal transmission in accordance with the embodiments of the present invention requires less buffer capacity and lower cost than the prior encryption/decryption apparatus because its encryption/decryption actions are directly completed. In addition, because the encryption/decryption action and transmit/receive action are not synchronous, the buffer situated between the encryption/decryption engines and transmit/receive control logic can effectively increase the wireless transmission speed. In another respect, the encryption/decryption signal generators are not limited to any specific algorithm; thus the present encryption/decryption apparatus features high extensibility.

In conclusion, the present invention is suitable to wireless communication apparatuses with high-speed transmission, especially to wireless communication apparatuses complying with the Institute of Electrical and Electronics Engineers (IEEE) 802.11 standards.

The above-described embodiments of the present invention are intended to be illustrative only. Numerous alternative embodiments may be devised by persons skilled in the art without departing from the scope of the following claims.

What is claimed is:

1. An encryption apparatus applied to wireless transmission, comprising:
an encryption engine configured to perform an encryption upon signals in a host;
a packet-transmitting buffer configured to store the encrypted signals; and
a transmit control logic configured to transmit the encrypted signals stored in the packet-transmitting buffer to a wireless network channel.

2. The apparatus of claim 1, wherein the encryption engine further comprises:
an interface controller configured to receive signals from the host;
an encryption signal generator configured to generate an encryption code; and
an operator configured to perform an operation upon the received signals and encryption code to generate the encrypted signals.

3. The apparatus of claim 2, wherein the operator performs an exclusive-or (XOR) operation.

4. A decryption apparatus applied to wireless transmission, comprising:
a receive control logic configured to receive signals intended for decryption from a wireless network channel;
a packet-receiving buffer configured to store the signals intended for decryption; and
a decryption engine configured to perform a decryption upon signals stored in the packet-receiving buffer and then to transmit the decrypted signals to a host.

5. The decryption apparatus of claim 4, wherein the decryption engine comprises:
an interface controller configured to transmit the decrypted signals to the host;
a decryption signal generator configured to generate a decryption code; and
an operator configured to perform an operation upon the signals intended for decryption and decryption code to generate the decrypted signals.

6. The decryption apparatus of claim 5, wherein the operator performs an exclusive-or (XOR) operation.

7. A wireless transceiver, comprising:
a transmitter comprising:
an encryption engine configured to perform an encryption upon signals in a host;
a packet-transmitting buffer configured to store the encrypted signals; and
a transmit control logic configured to transmit the encrypted signals stored in the packet-transmitting buffer;
a receiver comprising:
a receive control logic configured to receive signals intended for decryption;
a packet-receiving buffer configured to store the signals intended for decryption; and
a decryption engine configured to perform a decryption upon signals stored in the packet-receiving buffer and then to transmit the decrypted signals to another host.

8. The wireless transceiver of claim 7, wherein the encryption engine further comprises:
an interface controller configured to receive signals from the host;
an encryption signal generator configured to generate an encryption code; and
an operator configured to perform an operation upon the received signals and the encryption code to generate the encrypted signals.

9. The wireless transceiver of claim 8, wherein the operator performs an exclusive-or (XOR) operation.

10. The wireless transceiver of claim 7, wherein the decryption engine further comprises:
an interface controller configured to transmit the decrypted signals to another host;
a decryption signal generator configured to generate a decryption code; and
an operator configured to perform an operation upon the signals intended for decryption and the decryption code to generate the decrypted signals.

11. The wireless transceiver of claim 10, wherein the operator performs an exclusive-or (XOR) operation.

12. An encryption method applied to wireless transmission, comprising the steps of:
performing an encryption procedure upon signals intended for encryption in a host;
storing the encrypted signals to a buffer; and
transmitting the encrypted signals stored in the buffer to a wireless network channel.

13. The encryption method of claim 12, wherein the encryption procedure performs an exclusive-or (XOR) operation upon an encryption code and the signals intended for encryption.

14. A decryption method applied to wireless transmission, comprising the steps of:
storing signals intended for decryption from a wireless network channel to a buffer;
performing a decryption procedure upon signals intended for decryption from the buffer; and
transmitting the decrypted signals to a host.

15. The decryption method of claim 14, wherein the decryption procedure performs an exclusive-or (XOR) operation upon a decryption code and the signals intended for decryption.

16. A wireless signal transmission method, comprising the steps of:
performing an encryption procedure upon signals intended for encryption in a host;
storing the encrypted signals to a buffer;
transmitting the encrypted signals stored in the buffer;
receiving the encrypted signals and storing the encrypted signals in a buffer;
retrieving the encrypted signals from the buffer; and
performing a decryption procedure upon the encrypted signals in the buffer and transmitting the decrypted signals to a host.

17. The wireless signal transmission method of claim 16, wherein the encryption procedure performs an exclusive-or (XOR) operation upon an encryption code and the signals intended for encryption.

18. The wireless signal transmission method of claim 16, wherein the decryption procedure performs an exclusive-or (XOR) operation upon a decryption code and the signals intended for decryption.
